(19) United States
(12) Patent Application Publication
(10) Pub. No.: US 2007/0028272 A1
(43) Pub. Date: Feb. 1, 2007

(54) Live television show utilizing real-time input from a viewing audience

(75) Inventor: David B. Lockton, Carmel, CA (US)

Correspondence Address: HAVERSTOCK & OWENS LLP, 162 NORTH WOLFE ROAD, SUNNYVALE, CA, 94086, US

(73) Assignee: Airplay Network, Inc.

(21) Appl. No.: 11/495,853

(22) Filed: Jul. 27, 2006

Related U.S. Application Data
(60) Provisional application No. 60/704,809, filed on Aug. 1, 2005.

(51) Int. Cl. H04N 7/16

(52) U.S. Cl. 725/62; 725/135

(57) ABSTRACT

A live television show utilizing real-time input from a viewing audience is described herein. Specifically, the viewing audience is at home or at least not in the studio, and they use their cellular phones to input responses or make selections. The audience input is transmitted in real-time so that the producers of the television show are able to incorporate the results of the responses into the show. To permit an audience of millions to participate in real-time, a large random sample is utilized to provide real-time feedback. For example, the audience is able to determine the winner of a talent contest, which door is opened by a contestant, the results of a poll and affect the future direction of the telecast.

### RELATED APPLICATION(S)

This patent application claims priority under 35 U.S.C. §119(e) of the co-pending, co-owned U.S. Provisional Patent Application No. 60/704,809, filed Aug. 1, 2005, and entitled “A LIVE TELEVISION SHOW UTILIZING REAL TIME INPUT FROM THE VIEWING AUDIENCE” which is also hereby incorporated by reference in its entirety.

### FIELD OF THE INVENTION

The present invention relates to the field of distributed entertainment. More specifically, the present invention relates to the field of distributed entertainment utilizing a computing device where the entertainment corresponds to an event.

### BACKGROUND OF THE INVENTION

To date, the televised talent show American Idols is the most notable marriage of the cell phone and television viewers in the United States. During the live final events of this nationwide televised talent contest, AT&T® cell phone subscribers were permitted to vote for their favorite contestant. Over 12 million chose to do so. The results of those votes helped to determine the final winners. The methodology utilized was SMS messaging and dial-up telephone calls. These approaches have severe limitations when utilized for anything but a single expression of opinion during the timeframe of a telecast land line.

The capacity of the domestic phone system is severely constrained, and the TV show relied heavily on the cell phone. Many people were unable to deliver their text votes due to the flood of calls being generated at the same time. This bottleneck occurred even though the viewer interaction was basically one vote for a candidate, e.g., “A,” “B.” “C,” or “D,” near the end of the show. The phone system is designed to provide a dial tone to about 10% of the subscribers in any coverage area, which is the reason that during holidays like Mother's Day or during events like earthquakes one can get “all circuits are busy” messages.

The latency inherent in the cellular SMS messaging system generally delivers messages anywhere from 30 seconds to several hours after transmission. Thus, this cellular technology would not accommodate an audience participating in a live television show where the format of the show required frequent viewer input and/or votes to be taken and continually sent, received, and tabulated by the producers of a television show in the relatively short period of time (30 seconds), required to utilize the audience input in the format of the show.

Because of this delay, American Idol® and other television programs that incorporate home user interaction collect the data via cell phones on a first day and then the results are tabulated and announced a day later. As described, collecting results one day and displaying the results a second day is not useful for a live television program where feedback from the viewing audience is an integral part of the format during the show.

Some programs offer immediate feedback of home user interaction, but they utilize the Internet. For example, Music Television (MTV) and Country Music Television (CMT) have programs where one music video is displayed while the graphics and titles of two other videos are shown on the side of the screen. Home viewers then vote for the video they would like to watch next between the two videos on the side of the screen. As the currently playing video ends, a “winner” of the two side videos is selected based on the voting, and then that video begins playing.

Additionally, Who Wants to Be a Millionaire® implements a similar system. When the current contestant on the show uses the “lifeline” of polling the audience, a local audience is polled, as well as an AOL® audience at home. Viewers at home use their computers to input responses by selecting among the possible choices of A, B, C and D. Their selections are transferred over the Internet and are tallied so that the polling results are posted in time for the contestant to review them in making his/her decision. This approach requires the colocation of the personal computer and television, and also suffers capacity issues for the millions of simultaneous responses a show like American Idol® generates.

### SUMMARY OF THE INVENTION

A live television show utilizing real-time input from a viewing audience is described herein. Specifically, the viewing audience is at home or at least not in the studio, and they use their cellular phones to input responses or make selections. The audience input is transmitted in real-time so that the producers of the television show are able to incorporate the results of the responses into the show. To permit an audience of millions to participate in real-time, a large random sample is utilized to provide real-time feedback. For example, the audience is able to determine the winner of a talent contest, which door is opened by a contestant, the results of a poll and affect the future direction of the telecast.

In one aspect, a system for interactively participating in a television program, comprises a computer system, a cellular phone for coupling with the computer system to receive questions from and send responses to the computer system and a computing device coupled to the computer system for sending the questions to the computer system and receiving results from the computer system. The television program is live. The results are incorporated into the television program during airing of the television program. The results are incorporated by selecting from a group consisting of displaying poll information, determining a subsequent scene, directing a plot and selecting a winner based on votes. The cellular phone contains an application associated with the television program. The cellular phone utilizes Transmission Control Protocol to communicate with the computer system. The cellular phone must be registered to be permitted to submit responses. The cellular phone is selected randomly to be permitted to submit responses. The computer system is for determining participants, sending the questions to the cellular phone, gathering the responses from the cellular phone and determining the results from the responses. The television program is pre-recorded in segments, where segments are selected and played based on the results. All registered cellular phones are able to participate in a sweepstakes regardless of being randomly selected. The cellular phone is only able to cast one vote per question. The application within the cellular phone informs the cellular phone that it is selected to send a response. Alternatively, the application within the cellular phone informs the cellular phone that it is not selected to send a response. Alternatively, the cellular phone is informed to send a response from the computer system. Alternatively, the cellular phone is not informed to send a response from the computer system. An independent organization such as a Certified Public Accountancy (CPA) would certify that the statistical sample taken is both random and of sufficient size to represent the true opinion of the entire population of the registered television universe.

In another aspect, a system for interactively participating in a live television program, comprises a computer system containing a database for storing questions and results of responses, wherein the computer system is for determining participants, sending the questions, gathering responses and determining the results from the responses, one or more randomly selected cellular phones for coupling with the computer system through a cellular network to receive the questions from and send the responses to the computer system, wherein the cellular phone contains an application associated with the live television program and a computing device coupled to the computer system for sending the questions to and receiving the results from the computer system. The results are incorporated into the television program during airing of the television program. The results are incorporated by selecting from a group consisting of displaying poll information, determining a subsequent scene, directing a plot and selecting a winner based on votes. The cellular phones utilize Transmission Control Protocol to communicate with the computer system. The cellular phones must be registered to be selected to participate. All registered cellular phones are able to participate in a sweepstakes regardless of being randomly selected. The cellular phones are each only able to cast one vote per question.

In another aspect, a method of interactively participating in a television program, comprises sending one or more questions to a cellular phone from a computer system, receiving responses to the one or more questions at the computer system, generating results based on the responses and incorporating the results within the television program. The television program is live. Incorporating the results into the television program occurs during airing of the television program. Incorporating the results is selected from a group consisting of displaying poll information, determining a subsequent scene, directing a plot and selecting a winner based on votes. The method further comprises generating the one or more questions on a computing device. The computer system sends the one or more questions to a user via TCP or a one-way multi-cast connection. The method further comprises selecting a user to participate. Selecting the user to participate is random. The cellular phone must be registered for the user to be selected to participate. The method further comprises determining if a user is selected to participate in the one or more questions. Determining occurs when the user couples to the computer system. Alternatively, determining occurs after responding to the one or more questions. Alternatively, determining occurs when the user enters an application related to the television program on the cellular phone. The cellular phone contains an application associated with the television program. The method further comprises receiving and displaying the results on a computing device. All registered cellular phones are able to participate in a sweepstakes regardless of being randomly selected. The cellular phone is only able to cast one vote per question.

In another aspect, a method of interactively participating in a live television program, comprises randomly selecting a segment of registered users to respond to one or more questions, wherein each user in the segment of registered users has a cellular phone, sending the one or more questions to each of the cellular phones from a computer system, receiving responses to the one or more questions at the computer system, generating results based on the responses to the one or more questions at the computer system, receiving the results at a computing device for displaying the results and incorporating the results within the live television program. The method further comprises generating one or more questions on the computing device. The computer system sends the one or more questions to each user via TCP or a one-way multi-cast connection. The method further comprises sending a notification to each of the cellular phones of the selected segment of users. Incorporating the results is selected from a group consisting of displaying poll information, determining a subsequent scene, directing a plot and selecting a winner based on votes. All registered cellular phones are able to participate in a sweepstakes regardless of being randomly selected. The cellular phones are each only able to cast one vote per question.

In yet another aspect, a network of devices for allowing users to interactively participate in a television program, comprises a computer system containing a database for storing questions and results of responses, a plurality of cellular phones for coupling with the computer system through a cellular network to receive the questions from and send the responses to the computer system, wherein the plurality of cellular phones each contain an application associated with the television program and a computing device coupled to the computer system for sending the questions to and receiving the results from the computer system. The television program is live. The results are incorporated into the television program during airing of the television program. The results are incorporated by selecting from a group consisting of displaying poll information, determining a subsequent scene, directing a plot and selecting a winner based on votes. The plurality of cellular phones utilize Transmission Control Protocol to communicate with the computer system. The plurality of cellular phones must be registered to be permitted to submit responses. A segment of the plurality of cellular phones are selected randomly to be permitted to submit responses. The computer system is for determining participants, sending the questions to the cellular phones, gathering the responses from the cellular phones and determining the results from the responses. The television program is pre-recorded in segments, where segments are selected and played based on the results. All registered cellular phones are able to participate in a sweepstakes regardless of being randomly selected. The cellular phones are each only able to cast one vote per question.

In another aspect, a producer tool comprises an input device for receiving one or more questions from a producer, a network interface to couple to a computer system, wherein one or more questions are sent to the computer system and results are received from the computer system and a display device for displaying the results received from the computer system. The results are incorporated into a television program during airing of the television program. The results are incorporated by selecting from a group consisting of displaying poll information, determining a subsequent scene, directing a plot and selecting a winner based on votes. The television program is live. The one or more questions are sent to a plurality of cellular phones from the computer system and one or more responses are received at the computer system wherein the one or more responses are used to determine the results.

### BRIEF DESCRIPTION OF THE DRAWINGS

FIG. 1 illustrates a graphical representation of a preferred embodiment of the present invention.

FIG. 2 illustrates a flowchart of a method in a preferred embodiment of the present invention.

FIG. 3 illustrates a flowchart of a method of an embodiment of the present invention.

FIG. 4 illustrates a graphical representation of a network of devices of the present invention.

### DETAILED DESCRIPTION OF THE PREFERRED EMBODIMENT

A method and system for utilizing cellular phones to interactively participate in a live television show is described herein.

Although past cellular technologies were insufficient for live interaction, there are new technologies that will make live interaction possible. The new cellular 3G technologies, including EVDO, and other “multicast” technologies would allow TV based games of skill as described in U.S. patent application Ser. No. 11/166,596, filed on Jun. 24, 2005 and entitled Methods and Apparatus for Distributed Gaming Over a Mobile Device, herein incorporated by reference, to be fast-paced and formatted around continual input from the television viewing audience. For example, contestants in the home could literally compete against contestants in the TV studio on the live telecast.

The games of skill described in the aforementioned pending patent application, in order to meet economic capacity, and latency requirements, optimally utilize a one way broadcast architecture. In this system the ongoing results are not sent back to the central computer until the conclusion of the game. In certain circumstances described in U.S. patent application Ser. No. 11/166,596, filed on Jun. 24, 2005 and entitled Methods and Apparatus for Distributed Gaming Over a Mobile Device, random samples from a small subset of a universe of television viewers/competitors are continuously taken and utilized to inform the remaining significant majority of competitors where they stand at any time in the unfolding game.

The present invention addresses a live television show where some of the actions of the participants and the direction of the telecast are controlled by the majority vote of the viewing audience. This, for example, might be the next actions of a TV contestant, such as, for example, does the contestant open the left or right door? Do they attempt to answer question A, B, C, or D? Which team member should try which task next? Who should be voted off the island?

In a format similar to the Family Feud® television game show, the contestants might be asked to predict what the consensus of the viewing audience would be on a series of issues or questions. In any format, the tabulation of the will of the entire viewing audience must be fair and accurate, and not subject to possible manipulation, and accepted by the viewers as legitimate. Such audience input must also meet additional requirements.

The tabulation of the results of the response from the viewing audience must be almost immediate. Delays of 30-60 seconds to move to the next action, detracts from the viewer's enjoyment. Since anyone with a cellular phone is able to participate, the precise viewpoints of a potential universe of tens of millions are able to be obtained.

There was widespread concern over “voting blocks” of callers recruited and voting many times in the American Idols competition polling which skewed the results to be different from what an independent majority vote might otherwise be. The present invention addresses the capacity, speed, and accuracy requirements of such a television show. In some embodiments, users are only able to cast one vote per cellular phone.

The present invention applies the technology addressed in U.S. patent application Ser. No. 11/166,596, filed on Jun. 24, 2005 and entitled Methods and Apparatus for Distributed Gaming Over a Mobile Device to a live television show, where the will of the majority of the viewing audience expressed by a real time vote, directly impacts the content and direction of the telecast itself. As with the methodology of informing the competitor universe of their relative standing after each discrete event in massive games of skill, this invention leverages a real time random sampling approach.

From a universe of millions of viewers voting and/or expressing their opinions in real-time, along with a live television show, the central computer generates a random sample selection from all viewer participants who have registered to participate prior to the beginning of the event. If a game of skill is not simultaneously conducted with the telecast, an incentive event, such as a sweepstakes, could be offered to further motivate the audience to register prior to the beginning of the telecast. The central computer is directly accessible by the producers of the television live telecast underway utilizing the internet, or phone line.

In some embodiments, of the television viewers who have registered to participate, a random sample, for example, of 10,000 viewers is selected to establish a connection “on line” via a Transmission Control Protocol (TCP) connection to the central computer system. Along with all of those registered, only their responses are received, processed, and displayed to the television producers in a manner of seconds. If desired, the system facilitates a new and separate random sample for each separate polling event. In some embodiments, all of the participants are selected instead of a random sample.

In those embodiments in which a sample is taken, a signal is sent to the non-voting segment of the viewers, such as, for example, those whose phones will not actually transmit their selections, causing their attempt to send a response to remain at their cell phone. In the alternative, the game control software transmits a notification of selection as part of the random sample to those cell phones to be polled. Software loaded into the cell phone at registration could contain instructions that the phone is not to transmit a “vote” when a participant votes unless it has either received prior “permission” at the time of registration, or some time prior to the requested “vote” a communication is sent to select the phone to be part of the sample.

A large random sample of 10,000 has a very high degree of accuracy, such as, plus or minus (1%). The pervasiveness of political polls so prevalent in the media, has created a common understanding that a sample size of 1,000, with accuracy of plus, or minus 3% can be sufficient to accurately project the will of the people. Therefore, the confidence in the viewing audience of the viability, fairness, and accuracy of such a large sample is assured. By changing the sample audience with each discrete question, the reliability is further enhanced and the viewing audience made to feel that eventually their specific vote will be taken. If the results of the initial sample of 10,000, yields less than a 1% difference between the two or more alternatives, a second larger sample is able to be taken until the response is considered sufficiently definitive by an independent organization, such as a CPA firm, observing the voting procedures and results.

A separate contest for prizes could be conducted, based on awarding points to a home contestant for correctly predicting the majority choice, so that each and every one of the predictions not polled would have specific significance.

The underlying invention allows the television producers to obtain almost instantaneous results to questions and decisions, so that entertaining programs can be developed where there is no significant delay in the production of the television show underway. Its format and design can be designed to accommodate input from an audience, potentially in the tens of millions, within seconds of each question being asked of the audience. An audience of tens of millions will not create a bottleneck on either the hard wire or wireless networks, and the expense to the television show's producers will be minimized by eliminating potentially millions of calls.

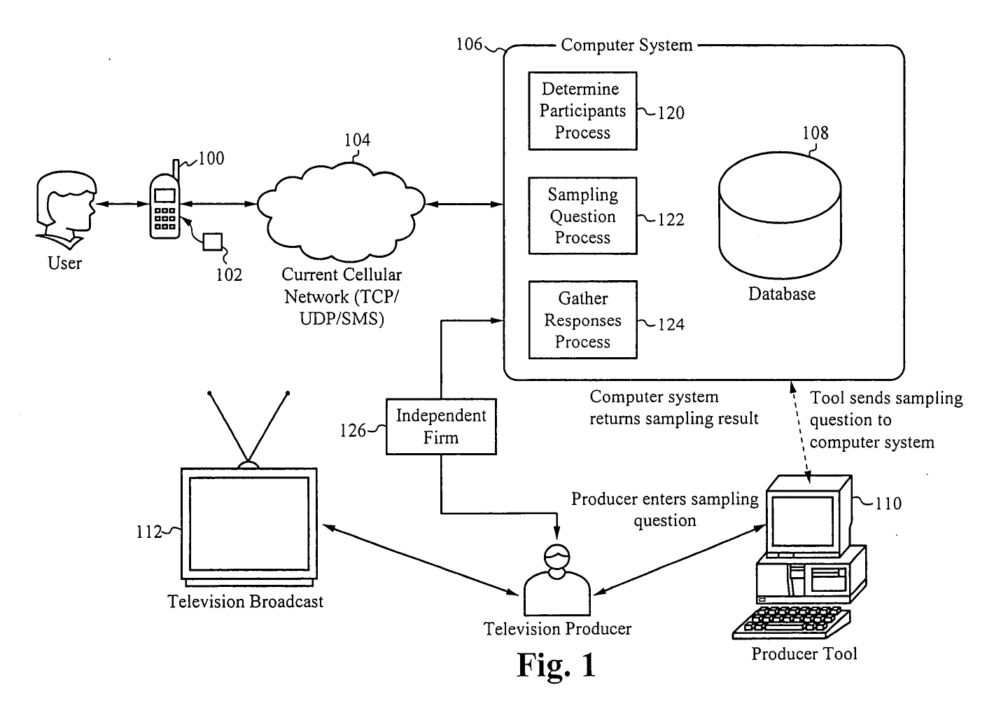

FIG. 1 illustrates a graphical representation of a preferred embodiment of the present invention. A user uses a cellular phone 100 to communicate through a cellular network 104 with a computer system 106. The cellular phone 100 contains an application 102 that is associated with the television event. For example, an application is specific to a Family Feud® show wherein users are asked questions such as “when do you typically go to bed?” However, if the application were related to the program American Idol®, instead of being asked a question, users would select which contestant they would like to remain on the show. In other embodiments, the application 102 is generic, so that it is able to be used with a variety of shows. In yet other embodiments, the application 102 is a bundle of similar applications so that a user is able to participate in television programs of a certain genre. For example, a talent contest bundle would include American Idol®, So You Think You Can Dance® and Dancing with the Stars®. All of these shows are similar in that contestants either sing, dance or do both and then the viewers select who they feel is the best.

The cellular phone 100 communicates over the cellular network 104 using TCP, UDP, SMS or any other appropriate protocol. The computer system 106 which communicates with the cellular phone 100 contains a database 108 to store questions to be sent to the users and results based on the responses that are received from the users. The computer system 106 also includes a participant determining process 120, a sampling question process 122 and a gather responses process 124. The participant determining process 120, randomly determines who will actively participate with a specified set of questions. The sampling question process 122 transmits the questions to the users who are part of the randomly determined sample. The gather responses process 124 gathers the users' responses after the questions are transmitted. In some embodiments, an independent organization 126, such as a CPA or accounting firm, is able to review the random selection process, the sample size and the results and certifies that each sample response accurately reflects the opinion of the registered viewing audience. After the desired review, the independent organization 126 is able to convey the results of the review with the producer.

Preferably, the computer system 106 is centrally located so that it is reachable by the users and one or more television producers or a person who is in control of a show. The computer system 106 is any computing device which is able to communicate with the users via the cellular network 104 and with a producer tool 110. A producer uses the producer tool 110 to couple to the computer system 106. The producer tool 110 is any computing device which is able to communicate with the computer system 106 which includes but is not limited to a personal computer, a laptop, a PDA or a cellular phone. The producer uses the producer tool 110 by entering questions which will later be transmitted to the users. The producer tool 110 then sends the questions to the computer system 106. During the television program, the computer system 106 sends the producer's submitted questions to the users, so that they are able to respond to them. An exemplary question would be, “Who would you like to remain?” After the users respond to the questions using their cellular phones 100, the computer system 106 sends the results to the producer tool 110. For example, 10,000 users are asked who would you like to remain. 5,000 users select A, 2,000 users select B, 2,000 users select C and 1,000 users select D as determined by the gather responses process 124. The results of that information is then transferred from the computer system 106 to the producer tool 110 where the producer is able to view the information. The producer is then able to incorporate that information in the television broadcast 112 as he chooses. For example, the producer is able to have the host of the show announce the results and inform D that he has received the fewest votes and is thus eliminated from the show.

The timing of events necessary to inform the user of the questions, receive their responses, gather the responses and then implement the television program based on the responses is able to be varied depending on the television program. For a program similar to American Idol® the question of “Who would you like to remain?” is able to be displayed on the show after each contestant performs and/or then quickly in a wrap-up after all of the performances. Then during a television break of a few minutes, users would have an opportunity to make their selections. This short break gives ample time to submit responses. It also is sufficient time for the computer system 106 to gather the responses and send the results to the producer tool 110 where the producer is able to review them. The producer then quickly decides what to do with the information, such as here, where the producer informs the host that contestant D has been eliminated. When the television show resumes after the commercial break, the host is able to inform the audience and the contestants of the results, and the show continues as desired from there.

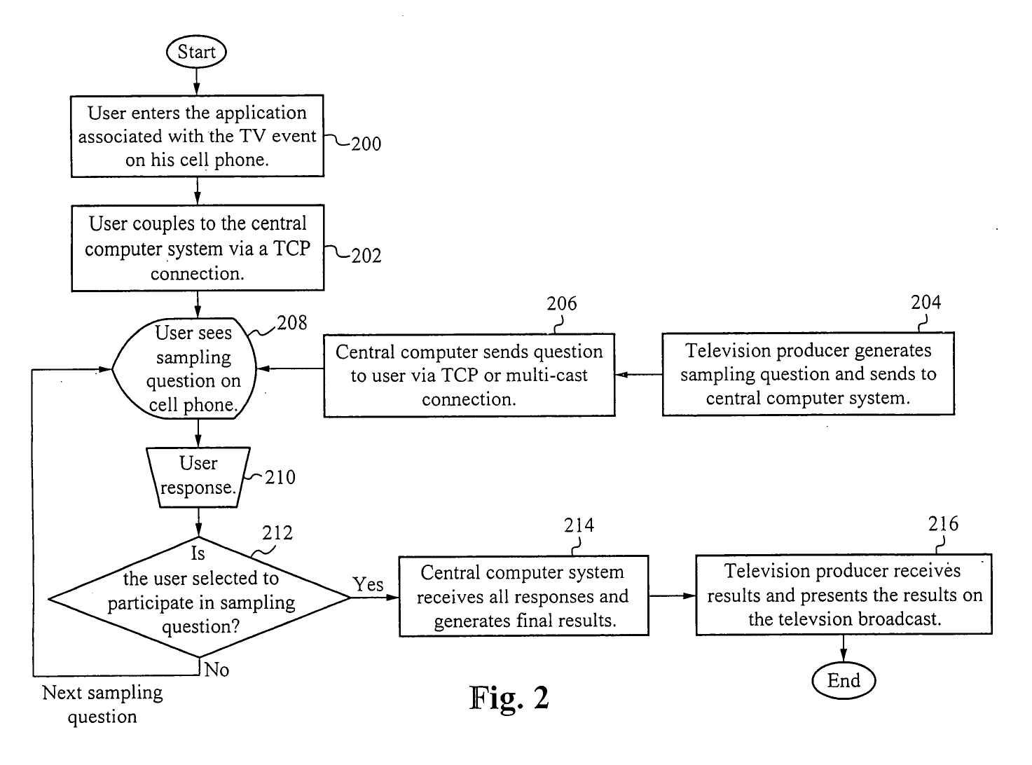

FIG. 2 illustrates a flowchart of a method in a preferred embodiment of the present invention. In the step 200, a user enters the application associated with the television event on his/her cellular phone. Preferably the television event is a live event. In the step 202, the user couples to the Central Computer System via a TCP connection. In other embodiments, a protocol other than TCP is implemented. In the step 204, a television producer generates a sampling question and sends it to the Cental Computer System. The Central Computer System then sends the question to the user via TCP or a multi-cast connection, in the step 206. In the step 208, the user sees the sampling question on his/her cellular phone. In the step 210, the user responds to the sampling question. In the step 212, it is determined if the user is selected to participate for the sampling question. In some embodiments, it is determined if a user has been selected to participate when he/she makes the initial connection to the Central Computer System. If the user is selected to participate, then the Central Computer System receives all of the responses related to that set of questions and generates a final set of results, in the step 214. In the step 216, the television producer receives the results and presents them on the television broadcast or utilizes them as desired. If the user is not selected to participate, then the user sees the next sampling question.

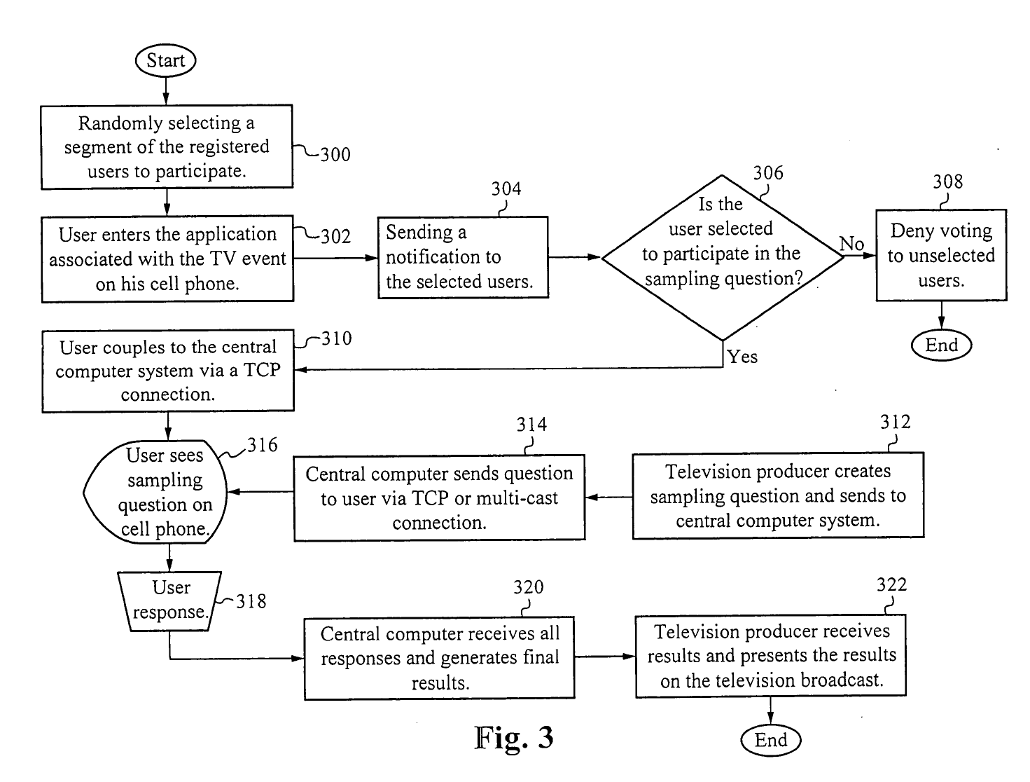

FIG. 3 illustrates a flowchart of a method of an embodiment of the present invention. In the step 300, a segment of the registered users are randomly selected to participate in the questions. The segment is able to vary as desired. For example, the same segment of users is able to be used for one episode of a show like American Idol®. The segment of users is able to vary throughout the show as well, so more people are involved. For example, a segment of users is utilized for a first question on Who Wants to Be A Millionaire®, another segment is used for a second question and so on. A user enters the application associated with the television event on his/her cellular phone, in the step 302. In some embodiments, the television event is live. After the user enters the application, in some embodiments a notification is sent to the selected users, in the step 304. In the step 306, it is determined if the user is selected to participate in the sampling question. If the user has not been selected, then his/her cellular phone is denied the ability to send a vote, in the step 308. If the user has been selected, then the user couples to the Central Computer System via a TCP connection, in the step 310. In other embodiments, a protocol other than TCP is implemented. In the step 312, a television producer generates a sampling question and sends it to the Cental Computer System. The Central Computer System then sends the question to the user via TCP or a multi-cast connection, in the step 314. In the step 316, the user sees the sampling question on his/her cellular phone. In the step 318, the user responds. The Central Computer System receives all of the responses related to that set of questions and generates a final set of results, in the step 320. In the step 322, the television producer receives the results and presents them on the television broadcast or utilizes them as desired.

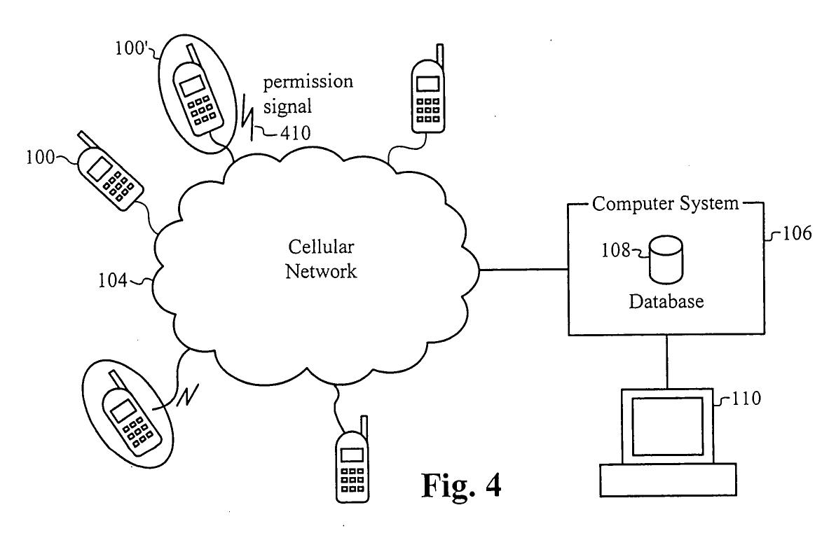

FIG. 4 illustrates a graphical representation of a network of devices of the present invention. A set of unselected cellular phones 100 and randomly selected cellular phones 100′ couple through a cellular network 104 to a computer system 106. The unselected cellular phones 100 and selected cellular phones 100′ are previously registered so that they are able to be randomly selected. In some embodiments, a permission signal 410 is sent to a cellular phone so that it becomes a selected cellular phone 100′. The computer system 106 sends questions to the selected cellular phones 100′. Users of the selected cellular phones 100′ are able to input their responses to the computer system 106 where the responses are gathered. Questions and results of the responses are stored in a database 108 on the computer system 106. Results of the responses are then sent from the computer system 106 to a producer tool 110. A producer is then able to review the results and utilize the information as he/she chooses to affect the television show.

In some embodiments, users not only make their selections through their cellular phone, but they also view the television program on their cellular phone. There are numerous applications for the present invention in addition to those described above. The present invention is able to be used with talent contests like American Idol® to have immediate results or to be able to involve the audience in the show more often, such as filtering some of the initial contestants out instead of just the final few.

America's Funniest Home Videos currently only allows the studio audience to vote, and they only vote from three or four selections already narrowed down by the producers. Utilizing the present invention, an at-home audience would be able to vote on each video throughout the show if the format of the show were slightly changed to accommodate such interaction. Moreover, instead of only the studio audience voting on the ultimate winner, an entire at-home audience would participate in the voting thus providing a better representation of the viewers.

For television drama shows, the at-home user interactivity would also add entertainment value. For example, with a pre-taped show like “24” the writers would have a number of splits in the script depending on the actions of a particular character which correspond with the at-home audience's selections. For instance, a character walks into a bar and notices two people sitting at different locations in the bar. The audience then selects which of the two people the character goes to talk to. Then, depending on the selection, that part of the script and storyline is acted out.

In a similar example, the split only occurs at the end of an episode. For example, the decision of which person to talk to occurs at the very end of the episode and then the following episode follows the storyline based on that selection. In the embodiments where actors must act out scenes, the filming is able to be live but is also able to be taped. For example, a typical hour-long television drama includes essentially four 10-minute clips, but instead, the producer and actors record a split for each 10 minutes. For instance, the first 10 minutes plays and then the audience is given a choice of selection A or B, where the scenes for both A and B have been previously recorded. Then, stemming from A is C or D and from B is E or F which are all also previously recorded. The process continues for an entire show. Hence, the entire show is able to be completely created beforehand; it just needs the audience to determine which parts of the show are actually viewed. Furthermore, since television shows are now sold on DVDs, the DVD is able to include all of the alternate storylines, so that the extra filming is not wasted. Although only two selections were described in the above example, any number of selections are possible.

In a similar application with regards to television dramas, variations of CSI, other police investigation shows and lawyer programs would be implemented where users use the information gathered to follow leads in an investigation, choose which witness to go talk to next or what questions to ask. The combination of the present invention with specially generated television shows or movies would turn television viewing into a role playing game. In some embodiments, at the end of a program, a contest is provided, and if users, for example, select the proper criminal based on the clues, they are awarded a prize.

The present invention is able to be used with sports wherein a most valuable player is selected for an event using cellular phones, with the advantage that everyone viewing is part of the sample, but the results are not delayed as with current SMS and other text messaging approaches. Adult entertainment programs would also be able to utilize the present invention.

Furthermore, currently the way re-runs of episodes are shown is that the television network cycles through episodes showing one after the other, usually showing ones that have been rated highly in the past. However, this occasionally leads to repetition of episodes and some episodes never being played again. Utilizing the present invention, instead of simply forcing viewers to watch a certain episode, for a short period of time before the episode starts, the network would present viewers with multiple episodes to choose from. Then, based on the users' input, the episode with the most votes is played.

Although some examples of applications have been given above, they are not meant to limit the present invention in any way. Any interactive television program is possible utilizing the present invention.

The present invention is utilized from multiple different perspectives. A user utilizes the invention by submitting responses or selections over his or her cellular phone. A producer of a television program enters the questions on a producer tool which sends the questions to a computer device which then transmits the questions to the user. The producer takes the results of the responses to the questions and incorporates them within the television program.

In operation, a segment of users are randomly selected out of a larger group of registered users. The selected segment of users can be any subset or all of the users, depending on the application. In some embodiments, the selected users are informed of being selected and, if desired, are informed over their cellular phones. The selected users are then able to respond to questions or select choices over their cellular phone. In some embodiments, everyone who is registered is able to vote. However, in those embodiments, only some of those who vote are randomly selected to generate the results. A producer generates the questions that the users respond to on a producer tool which sends the questions to a computer system. The computer system then sends the questions to and receives the responses from the users. The computer system also determines the results of the responses and sends them to the producer tool where the producer is able to review the results and incorporate them within the television program. The questions sent to the users are related to the television program and thus provide users with a highly interactive experience.

In an alternative embodiment, the computer system and the producer tool are the same computing device. In other embodiments, instead of the computer system sending questions to users' cellular phones, the questions, surveys or other interactive requests are presented on the television program. For example, a host of a show will say, “vote now for your favorite singer.”

Some telecasts are broadcast live in the Eastern time zone and then rebroadcast for the West coast on tape delay, such as the Emmy's and other East coast staged live events. The large statistical sample utilized in the Eastern time zone still accurately represents the will of the audience, and the fact that the West Coast audience might not actually vote will not diminish the entertainment value of the “live taped” format for West Coast viewers.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for interactively participating in a television program, comprising:
a. a computer system;
b. a cellular phone for coupling with the computer system to receive questions from and send responses to the computer system; and
c. a computing device coupled to the computer system for sending the questions to the computer system and receiving results from the computer system.

2. The system as claimed in claim 1 wherein the television program is live.

3. The system as claimed in claim 1 wherein the results are incorporated into the television program during airing of the television program.

4. The system as claimed in claim 3 wherein the results are incorporated by selecting from the group consisting of displaying poll information, determining a subsequent scene, directing a plot and selecting a winner based on votes.

5. The system as claimed in claim 1 wherein the cellular phone contains an application associated with the television program.

6. The system as claimed in claim 1 wherein the cellular phone utilizes Transmission Control Protocol to communicate with the computer system.

7. The system as claimed in claim 1 wherein the cellular phone must be registered to be permitted to submit responses.

8. The system as claimed in claim 7 wherein the cellular phone is selected randomly to be permitted to submit responses.

9. The system as claimed in claim 1 wherein the computer system is for determining participants, sending the questions to the cellular phone, gathering the responses from the cellular phone and determining the results from the responses.

10. The system as claimed in claim 1 wherein an independent auditing organization inspects the system for random selection, sample size and the results and certifies that each sample response accurately reflects the opinion of a registered audience.

11. The system as claimed in claim 1 wherein the television program is pre-recorded in segments, where segments are selected and played based on the results.

12. The system as claimed in claim 7 wherein all registered cellular phones are able to participate in a sweepstakes regardless of being randomly selected.

13. The system as claimed in claim 1 wherein the cellular phone is only able to cast one vote per question.

14. The system as claimed in claim 5 wherein the application within the cellular phone informs the cellular phone that it is selected to submit a response.

15. The system as claimed in claim 5 wherein the application within the cellular phone informs the cellular phone that it is not selected to submit a response.

16. The system as claimed in claim 1 wherein the cellular phone is informed to send a response from the computer system.

17. The system as claimed in claim 1 wherein the cellular phone is not informed to send a response from the computer system.

18. A system for interactively participating in a live television program, comprising:
a. a computer system containing a database for storing questions and results of responses, wherein the computer system is for determining participants, sending the questions, gathering responses and determining the results from the responses;
b. one or more randomly selected cellular phones for coupling with the computer system through a cellular network to receive the questions from and send the responses to the computer system, wherein the cellular phone contains an application associated with the live television program; and
c. a computing device coupled to the computer system for sending the questions to and receiving the results from the computer system.

19. The system as claimed in claim 18 wherein the results are incorporated into the television program during airing of the television program.

20. The system as claimed in claim 19 wherein the results are incorporated by selecting from the group consisting of displaying poll information, determining a subsequent scene, directing a plot and selecting a winner based on votes.

21. The system as claimed in claim 18 wherein the cellular phones utilize Transmission Control Protocol to communicate with the computer system.

22. The system as claimed in claim 18 wherein the cellular phones must be registered to be selected to participate.

23. The system as claimed in claim 18 wherein all registered cellular phones are able to participate in a sweepstakes regardless of being randomly selected.

24. The system as claimed in claim 18 wherein the cellular phones are each only able to cast one vote per question.

25. A method of interactively participating in a television program, comprising:
a. sending one or more questions to a cellular phone from a computer system;
b. receiving responses to the one or more questions at the computer system;
c. generating results based on the responses; and
d. incorporating the results within the television program.

26. The method as claimed in claim 25 wherein the television program is live.

27. The method as claimed in claim 25 wherein incorporating the results into the television program occurs during airing of the television program.

28. The method as claimed in claim 27 wherein incorporating the results is selected from the group consisting of displaying poll information, determining a subsequent scene, directing a plot and selecting a winner based on votes.

29. The method as claimed in claim 25 further comprising generating the one or more questions on a computing device.

30. The method as claimed in claim 25 wherein the computer system sends the one or more questions to a user via TCP or a one-way multi-cast connection.

31. The method as claimed in claim 25 further comprising selecting a user to participate.

32. The method as claimed in claim 31 wherein selecting the user to participate is random.

33. The method as claimed in claim 31 wherein the cellular phone must be registered for the user to be selected to participate.

34. The method as claimed in claim 25 further comprising determining if a user is selected to participate in the one or more questions.

35. The method as claimed in claim 34 wherein determining occurs when the user couples to the computer system.

36. The method as claimed in claim 34 wherein determining occurs after responding to the one or more questions.

37. The method as claimed in claim 34 wherein determining occurs when the user enters an application related to the television program on the cellular phone.

38. The method as claimed in claim 25 wherein the cellular phone contains an application associated with the television program.

39. The method as claimed in claim 25 further comprising receiving and displaying the results on a computing device.

40. The method as claimed in claim 25 wherein all registered cellular phones are able to participate in a sweepstakes regardless of being randomly selected.

41. The method as claimed in claim 25 wherein the cellular phone is only able to cast one vote per question.

42. A method of interactively participating in a live television program, comprising:
a. randomly selecting a segment of registered users to respond to one or more questions, wherein each user in the segment of registered users has a cellular phone;
b. sending the one or more questions to each of the cellular phones from a computer system;
c. receiving responses to the one or more questions at the computer system;
d. generating results based on the responses to the one or more questions at the computer system;
e. receiving the results at a computing device for displaying the results; and
f. incorporating the results within the live television program.

43. The method as claimed in claim 42 further comprising generating one or more questions on the computing device.

44. The method as claimed in claim 42 wherein the computer system sends the one or more questions to each user via TCP or a one-way multi-cast connection.

45. The method as claimed in claim 42 further comprising sending a notification to each of the cellular phones of the selected segment of users.

46. The method as claimed in claim 42 wherein incorporating the results is selected from the group consisting of displaying poll information, determining a subsequent scene, directing a plot and selecting a winner based on votes.

47. The method as claimed in claim 42 wherein all registered cellular phones are able to participate in a sweepstakes regardless of being randomly selected.

48. The method as claimed in claim 42 wherein the cellular phones are each only able to cast one vote per question.

49. A network of devices for allowing users to interactively participate in a television program, comprising:
a. a computer system containing a database for storing questions and results of responses;
b. a plurality of cellular phones for coupling with the computer system through a cellular network to receive the questions from and send the responses to the computer system, wherein the plurality of cellular phones each contain an application associated with the television program; and
c. a computing device coupled to the computer system for sending the questions to and receiving the results from the computer system.

50. The network of devices as claimed in claim 49 wherein the television program is live.

51. The network of devices as claimed in claim 49 wherein the results are incorporated into the television program during airing of the television program.

52. The network of devices as claimed in claim 51 wherein the results are incorporated by selecting from the group consisting of displaying poll information, determining a subsequent scene, directing a plot and selecting a winner based on votes.

53. The network of devices as claimed in claim 49 wherein the plurality of cellular phones utilize Transmission Control Protocol to communicate with the computer system.

54. The network of devices as claimed in claim 49 wherein the plurality of cellular phones must be registered to be permitted to submit responses.

55. The network of devices as claimed in claim 54 wherein a segment of the plurality of cellular phones are selected randomly to be permitted to submit responses.

56. The network of devices as claimed in claim 49 wherein the computer system is for determining participants, sending the questions to the cellular phones, gathering the responses from the cellular phones and determining the results from the responses.

57. The network of devices as claimed in claim 49 wherein the television program is pre-recorded in segments, where segments are selected and played based on the results.

58. The network of devices as claimed in claim 49 wherein all registered cellular phones are able to participate in a sweepstakes regardless of being randomly selected.

59. The network of devices as claimed in claim 49 wherein the cellular phones are each only able to cast one vote per question.

60. A producer tool for producing an interactive television program comprising:
a. an input device for receiving one or more questions from a producer;
b. a network interface configured to couple to a computer system, wherein one or more questions are sent to the computer system to then be sent to viewers through cellular phones and results are received from the viewers through the computer system; and
c. a display device for displaying the results received from the computer system at the producer tool.

61. The producer tool as claimed in claim 60 wherein the results are incorporated into a television program during airing of the television program.

62. The producer tool as claimed in claim 61 wherein the results are incorporated by selecting from the group consisting of displaying poll information, determining a subsequent scene, directing a plot and selecting a winner based on votes.

63. The producer tool as claimed in claim 61 wherein the television program is live.
